(19) United States
(12) Patent Application Publication
(10) Pub. No.: US 2013/0305607 A1
(43) Pub. Date: Nov. 21, 2013

(54) SMOKE AND HEAT EVACUATOR

(71) Applicant: Aimone Balbo Di Vinadio, Chiusa San Michele (Torino) (IT)

(72) Inventor: Aimone Balbo Di Vinadio, Chiusa San Michele (Torino) (IT)

(21) Appl. No.: 13/981,419

(22) PCT Filed: Feb. 10, 2012
(86) PCT No.: PCT/IB2012/050613

§ 371 Date: Jul. 24, 2013

(30) Foreign Application Priority Data
Feb. 11, 2011 (IT) TO2011A000115

(51) Int. Cl. E05F 15/20; A62C 2/24

(52) U.S. Cl. CPC E05F 15/2015; A62C 2/24
USPC 49/1

(57) ABSTRACT

A smoke and heat evacuator that can be applied at an opening of a generally vertical wall of a closed environment, includes a supporting frame bearing a shutter, which oscillates between a normally closed position and an open position via at least one lateral linkage having a first arm that, in the closed position, extends obliquely, with a top end articulated to the shutter via a slider subject to the downward-thrust action of a spring and with a bottom end articulated to the supporting frame via a second lengthenable arm.

### CROSS-REFERENCE TO RELATED APPLICATIONS

This application is a 371 national stage of PCT International Application No. PCT/IB2012/050613 filed on Feb. 10, 2012, and published in English on Aug. 16, 2012 as WO 2012/107903 A1, which claims priority from Italian Patent Application No. TO2011A000115 filed on Feb. 11, 2011, the entire disclosures of which are incorporated herein by reference.

### FIELD OF THE INVENTION

The present invention relates to devices for evacuation of smoke and heat from closed environments in the event of fire.

More in particular, the subject of the invention is an evacuator that can be applied at an opening of a generally vertical wall of the premises and comprises a supporting frame bearing a shutter oscillating about the axis of hinges set at its bottom side and mobile between a normally closed position, in which the opening is obstructed in a fluid-tight way, and an open position to enable evacuation of smoke and heat through said opening. Operatively associated to the oscillating shutter are releasable means for blocking thereof in the closed position and actuator means for controlling displacement thereof into the open position following upon release of the blocking means.

### PRIOR ART

In known smoke and heat evacuators of the type indicated above, an example of which is disclosed in U.S. Pat. No. 4,068,417, for governing displacement for opening of the shutter motor-driven actuators are typically provided, for example electrically operated ones or hydraulically operated ones, which entail problems of overall dimensions and costs, in addition to problems of reliability in so far as they are subject to risks of breakdown or malfunctioning. In addition, the presence of actuators of this sort can limit the section of passage of smoke and heat through the opening.

### SUMMARY OF THE INVENTION

The object of the present invention is to overcome the aforesaid drawbacks, and to provide a smoke and heat evacuator of the type defined at the start of the description that will prevent, in its displacement for opening, use of motor-driven actuators, at the same time ensuring the maximum section of passage through the opening.

According to the invention, the above object is achieved thanks to the fact that the aforesaid actuator means for governing displacement of the shutter from the closed position to the open position comprise at least one linkage that interconnects laterally the shutter and the supporting frame and comprises a first arm that, in the closed position, extends obliquely, with a top end articulated to the shutter via a slider subject to the action of thrust downwards of a spring, and a bottom end articulated to the supporting frame via a second arm that can be lengthened as far as a condition, corresponding to the open position of the shutter, in which it is aligned on the prolongation of the first arm.

Preferably, the second arm is formed by a pair of levers that are folded parallel to the shutter when the latter is in the closed position and that can be unfolded during opening.

Advantageously, the aforesaid slider is able to slide along a lateral guide of the shutter, set in the bottom area of which is a spring for damping the travel of the slider at the end of opening of the shutter.

### BRIEF DESCRIPTION OF THE DRAWINGS

The invention will now be described in detail with reference to the annexed drawings, which are provided purely by way of non-limiting example and in which:

FIG. 1 is a schematic perspective view that shows the smoke and heat evacuator according to the invention in the closed position;

FIG. 2 is a view in side elevation and partially cut away of the evacuator in the closed position;

FIG. 3 is a view similar to that of FIG. 2 that shows the evacuator in the open position;

FIG. 4 is a view similar to that of FIG. 2, rotated through 180° and in partial vertical section; and

FIGS. 5-10 are views similar to that of FIG. 4 that show the smoke and heat evacuator in the course of respective successive steps during its opening.

### DETAILED DESCRIPTION OF THE INVENTION

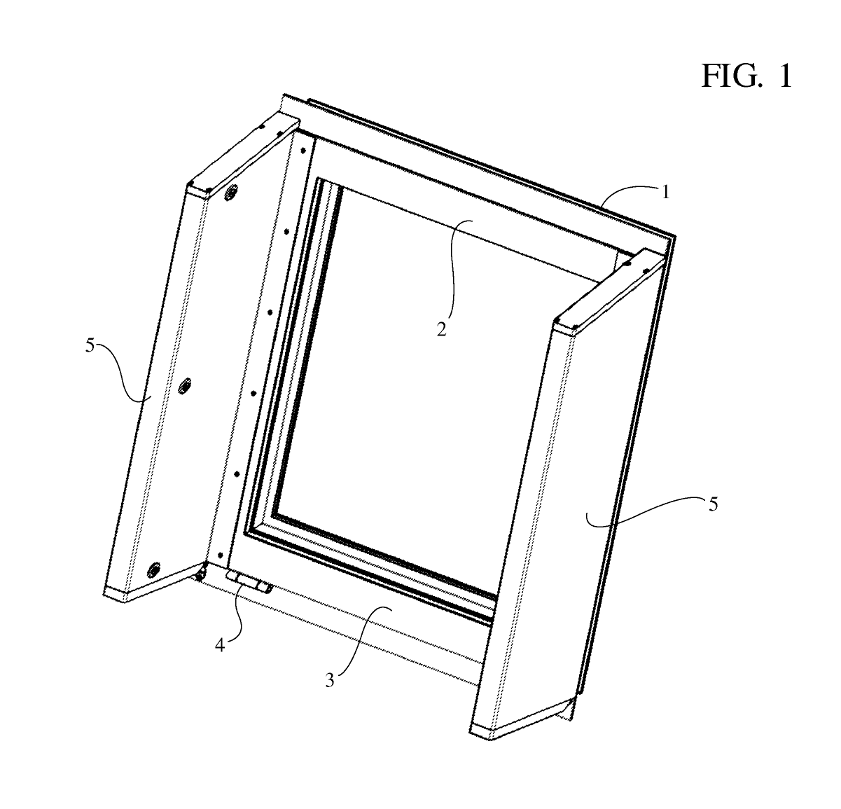

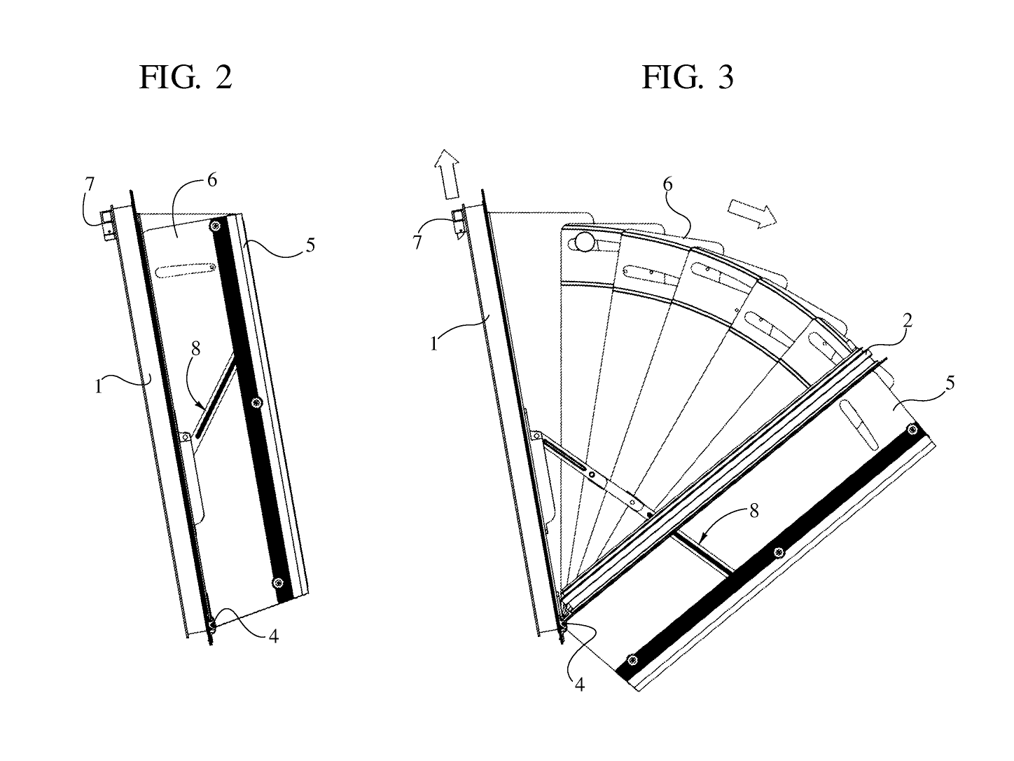

With initial reference to FIGS. 1 to 3, a smoke and heat evacuator according to the invention basically comprises a supporting frame 1 and an oscillating shutter 2 that can be displaced with respect to the frame 1 between a closed position, represented in FIGS. 1 and 2, and an open position illustrated in FIG. 3.

The frame 1 can be applied at an opening of a generally vertical wall, typically setting it with a slight inclination with respect to the vertical, for example, in the region of 10° in a direction opposite to the direction of opening of the shutter 2.

The shutter 2 is articulated at its bottom side 3 to the frame 1, via one or more hinges 4, and in the closed position represented in FIGS. 1 and 2 it obstructs the opening in a fluid-tight way. In its position of complete opening, represented in FIG. 3, the shutter 2 is rotated around the axis of the hinges 4 downwards, for example by an angle of about 60° starting from the closed position, so as to enable outflow of smoke and heat towards the outside of the premises and upwards.

Provided along the opposite sides of the shutter 2 are two cowlings 5 projecting outwards and housed within each of which is a respective lateral fan-like mechanism 6 formed by a series of sectors connected together, the first one of which is fixed to the frame 1 and the last is articulated to the cowling 5. In the closed position of the shutter 2 the sectors of the fan-like mechanism 6 are gathered together alongside one another, whilst in the open position of the shutter 2 they splay out in the way represented in FIG. 3. In this way, in use, the flow of smoke and hot air in the open position of the shutter 2 is channeled between the latter and the two fan-like structures 6.

For blocking the shutter 2 in the open position any conventional device can be provided that is designed to withhold its top side at the top side of the frame 1 and can be remote controlled to enable oscillation of the shutter 2 into the open position. The blocking device can be, for example, constituted by a catch 7 of an electromechanical type, that can be operated at a distance.

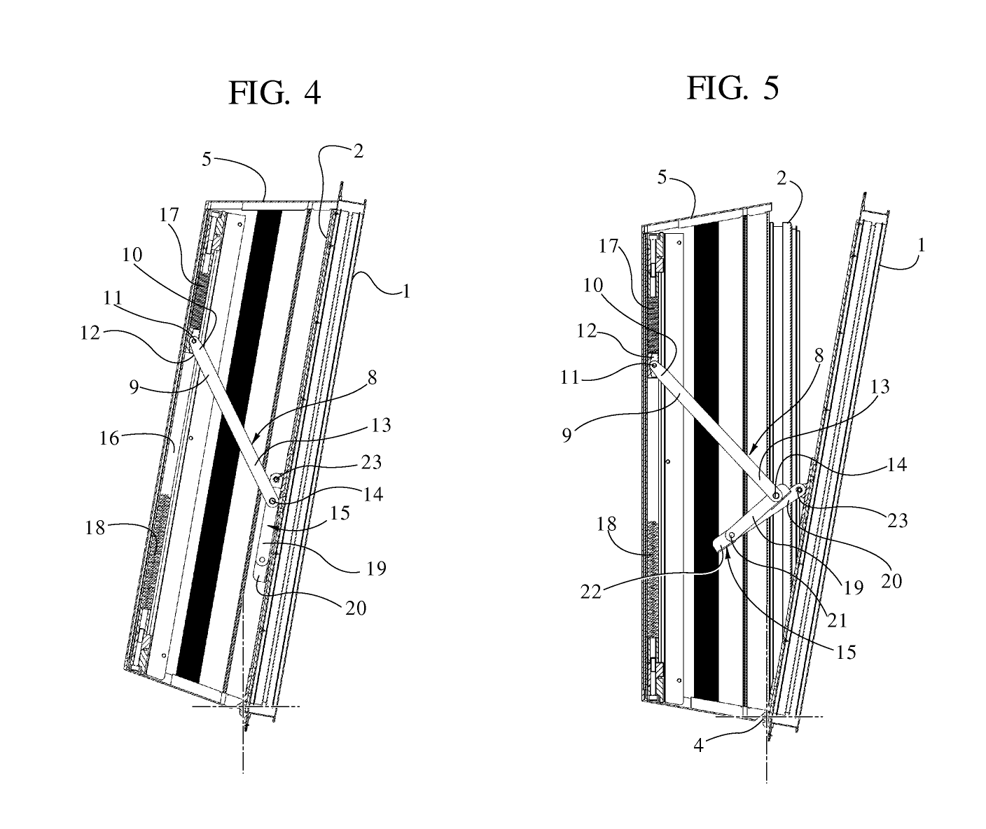

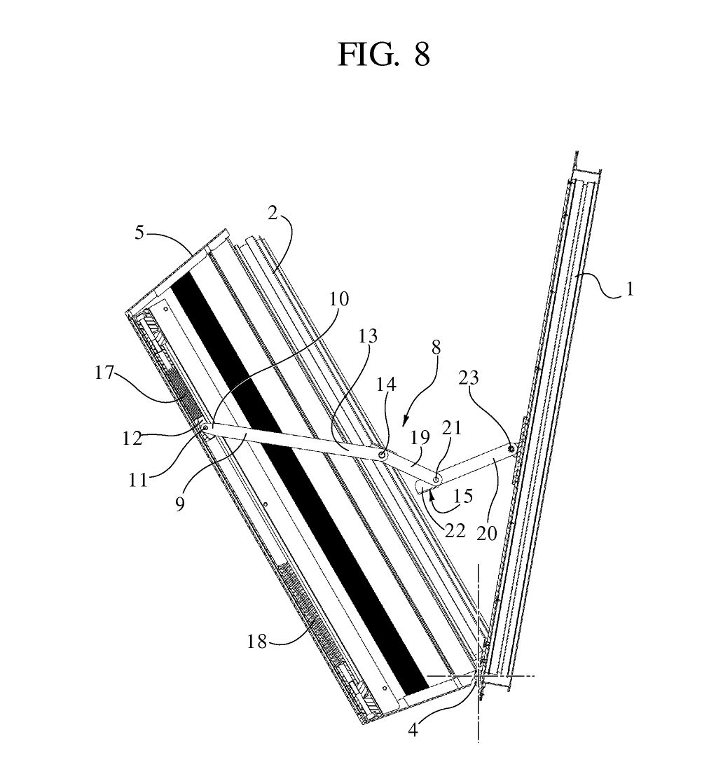

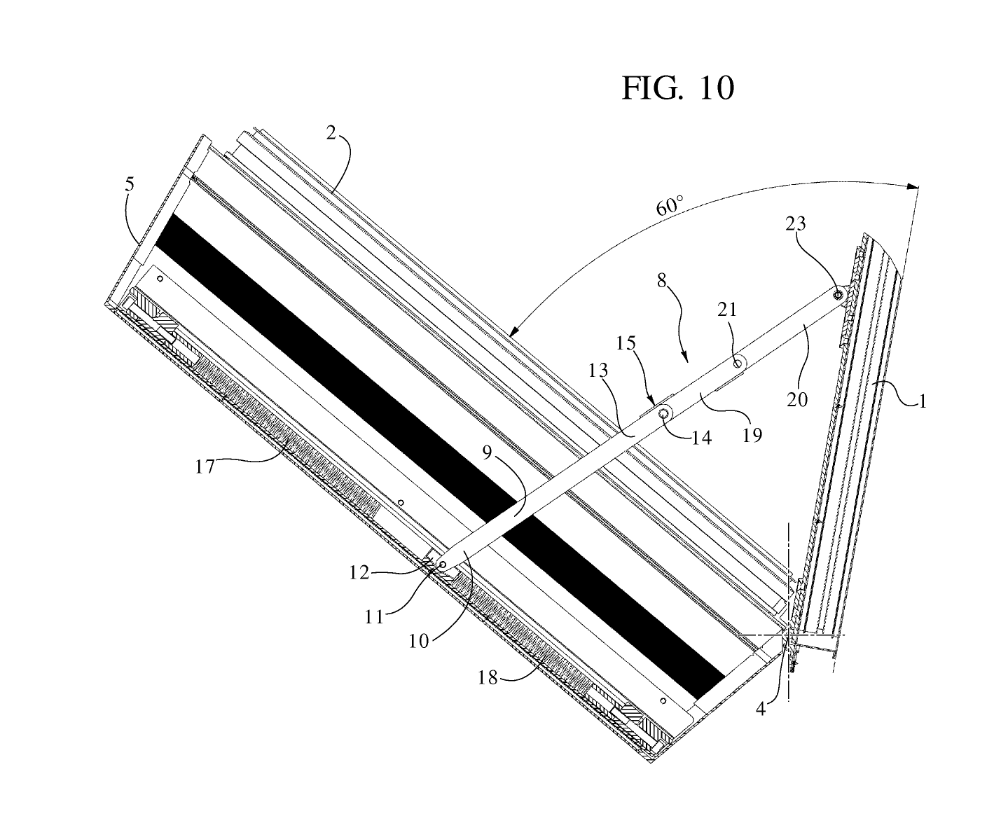

In order to govern displacement of the shutter 2 from the closed position to the open position, following upon release of the blocking device 7, the invention envisages in a peculiar way an entirely mechanical system, which hence does not require the aid of electric or hydraulic actuators. This system is exemplified in FIGS. 4 to 10, with reference to the various successive steps of its operation starting from the closed position of the shutter 2 (FIG. 4) up to its complete opening (FIG. 10). This mechanical system includes, for at least one side of the evacuator and preferably for both sides, a linkage designated as a whole by 8 comprising a first articulated arm 9, which, in the closed position of the shutter 2 represented in FIGS. 2 and 4, extends obliquely, with a top end 10 articulated in 11 to a slider 12 and a bottom end 13 articulated in 14 to a second arm 15. The slider 12 is able to slide within a guide 16 formed along the front part of the cowling 5, and reacting against said slider 12 is a helical thrust spring 17, which, in the closed condition of the shutter 2, is compressed and tends to push the slider 12 downwards.

Housed in the bottom part of the guide 16 is a second helical compression spring 18 having, as will be seen in what follows, the function of damping the slider 12 at the end of its travel downwards.

The second arm 15 can lengthen, and more in particular, in the case of the example illustrated, is constituted by a pair of levers 19, 20, which, in the closed condition of the shutter 2, are folded alongside one another parallel to the frame 1, in a condition of minimum length of the second arm 15, and during opening of the shutter 2 can be unfolded until they reach a maximum length of the second arm 15. The lever 19 is articulated on one side in 14 to the first arm 9 and on the opposite side in 21 to the second lever 20, which in turn is articulated in 23 to the frame 1.

Opening of the smoke and heat evacuator according to the invention will now be described with reference to the various successive steps represented in FIGS. 4 to 9, in which for simplicity of illustration the fan-like structure 6 is omitted.

As already clarified, in the closed condition of the shutter 2 represented in FIG. 4, the slider 12 is set in the top area of the guide 16 under the action of thrust of the spring 17, and the two levers 19, 20 of the second arm 15 are folded alongside one another against the supporting frame 1.

When a command is sent for release of the blocking device 7, the top side of the shutter 2 disengages from the frame 1, and this releases the action of the thrust spring 17, which starts to press the slider 12, and hence the top end 10 of the first arm 8, downwards. In this initial step, the first arm 8 hence acts like a strut, reacting through the second arm 15 against the frame 1 to cause an initial angular displacement of the shutter 2 from the initial position, which, as has been said, is inclined by approximately 10° backwards, into a substantially vertical position and beyond (FIG. 5).

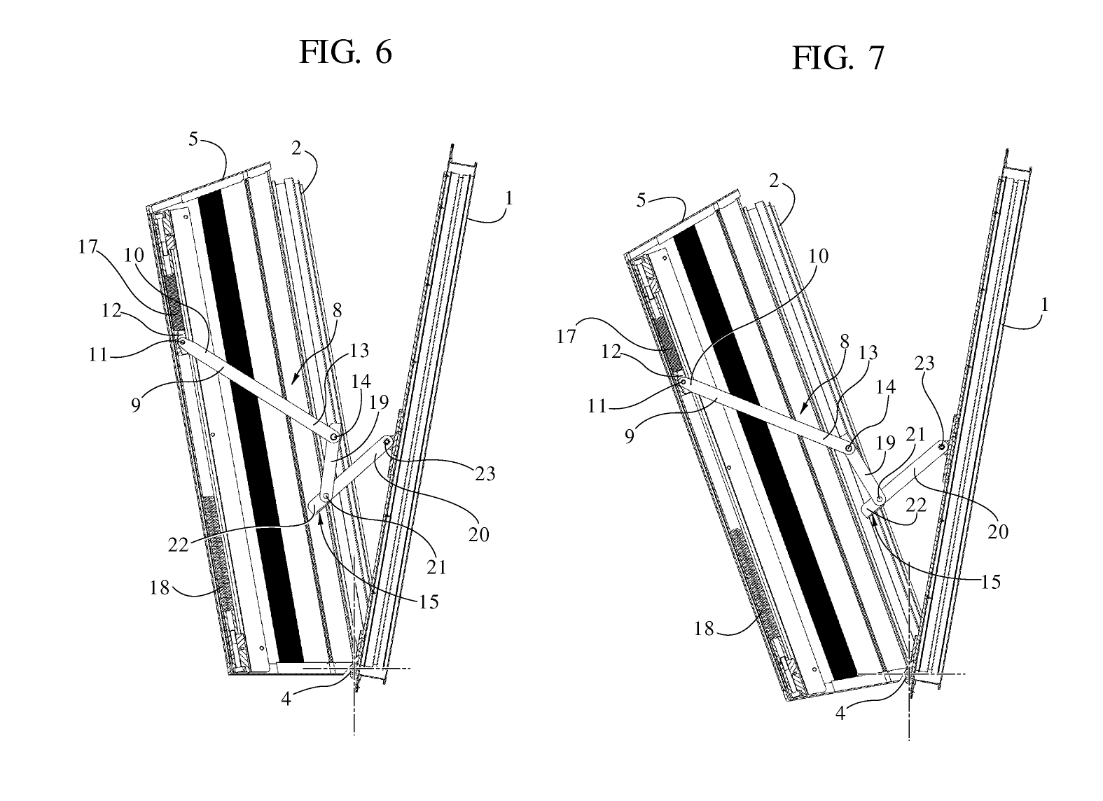

Rotation forwards and downwards of the shutter 2 then proceeds by gravity, whilst simultaneously gradual unfolding of the second arm 15 takes place as a result first of a rotation upwards of the levers 19 and 20 (FIG. 5), and then of the divarication of the lever 19 with respect to the lever 20 (FIGS. 6, 7, and 8), drawn by the first arm 9 during further oscillation downwards of the shutter 2.

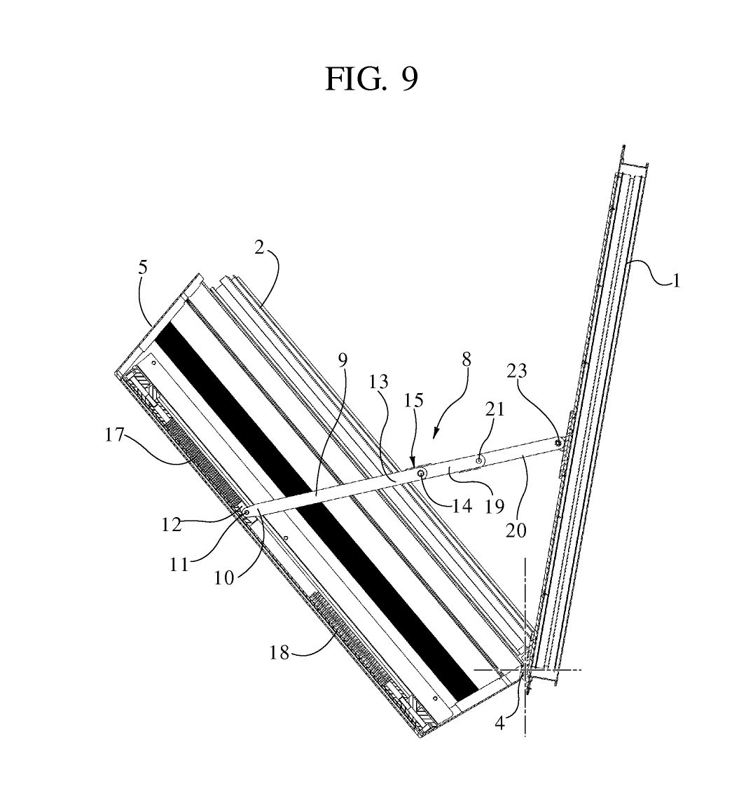

When the levers 19 and 20 of the first arm 15 set themselves in a condition of mutual alignment on the prolongation of the first arm 9 (FIG. 9) the further oscillation downwards of the shutter 2 causes a final translation of the slider 12 towards the bottom area of the guide 16, until the slider comes to bear upon the damping spring 18, in the way represented in FIG. 10. This produces the damped arrest of the shutter 2 in the condition of complete opening in which it forms an angle for example of approximately 50° with the vertical, for a total angular range (starting from the closed position in which, as has been said, it was inclined backwards by approximately)10° of approximately 60°.

The entire cycle of opening of the shutter 2 starting from the moment of release of the blocking device 7 is obtained in an extremely fast way, as required by an emergency in the event of fire, whilst for its subsequent, return into the closed position solutions of a manual or mechanised type may be envisaged that are within the reach of a person skilled in the branch.

Of course, the details of construction and the embodiments may vary widely with respect to what is described and illustrated herein, without thereby departing from the scope of the present invention.

Thus, for example, the modalities of lengthening of the second arm 15 of the linkage 8 may envisage, instead of unfolding of the two articulated levers 19, 20, a mutual telescopic sliding thereof or else the use of a pin of one lever that can slide within a longitudinal slit of the other lever.

1. A smoke and heat evacuator that can be applied at an opening of a generally vertical wall of a closed environment, comprising:
a supporting frame bearing a shutter, which oscillates about an axis of hinges set at a bottom side of said shutter and is mobile between a normally closed position, in which said opening is obstructed, and an open position to enable evacuation of smoke and heat through said opening,
means for releasable blocking of the shutter in said closed position, and
actuator means for governing displacement of said shutter from said closed position to said open position following upon release of said blocking means, and
said actuator means comprising at least one linkage that interconnects laterally said shutter and said supporting frame and comprises a first arm that, in said closed position, extends obliquely with a top end articulated to the shutter via a slider subject to a downward-thrust action of a spring and with a bottom end articulated to the supporting frame via a second arm that can be lengthened into a condition, corresponding to said open position of the shutter, in which said second arm is aligned on the prolongation of the first arm.

2. The evacuator according to claim 1, wherein said second arm is formed by a pair of levers articulated to one another folded against said supporting frame when the shutter is set in said closed position.

3. The evacuator according to claim 1, wherein said slider is able to slide along a lateral guide, which is fixed with respect to the shutter and set in the bottom part of which is a spring for damping said slider at the end of opening of said shutter.

4. The evacuator according to claim 1, further comprising a pair of lateral fan-like structures that can be opened out during opening of said shutter.

5. The evacuator according to claim 1, wherein said actuator means comprise a pair of said linkages that interconnect laterally said shutter and said supporting frame.

6. The evacuator according to claim 2, wherein said slider is able to slide along a lateral guide, which is fixed with respect to the shutter and set in the bottom part of which is a spring for damping said slider at the end of opening of said shutter.

7. The evacuator according to claim 2, further comprising a pair of lateral fan-like structures that can be opened out during opening of said shutter.

8. The evacuator according to claim 3, further comprising a pair of lateral fan-like structures that can be opened out during opening of said shutter.

9. The evacuator according to claim 2, wherein said actuator means comprise a pair of said linkages that interconnect laterally said shutter and said supporting frame.

10. The evacuator according to claim 3, wherein said actuator means comprise a pair of said linkages that interconnect laterally said shutter and said supporting frame.

11. The evacuator according to claim 4, wherein said actuator means comprise a pair of said linkages that interconnect laterally said shutter and said supporting frame.
